(19) United States
(12) Patent Application Publication
(10) Pub. No.: US 2010/0030685 A1
(43) Pub. Date: Feb. 4, 2010

(54) TRANSACTION ANALYSIS

(76) Inventors: Russell P. Bobbitt, Pleasantville, NY (US); Sergio Borger, Demarest, NJ (US); Jonathan H. Connell, II, Cortlandt-Manor, NY (US); Myron D. Flickner, San Jose, CA (US); Norman Haas, Mount Kisco, NY (US); Arun Hampapur, Norwalk, CT (US); Sharathchandra U. Pankanti, Norwalk, CT (US); Unsang Park, East Lansing, MI (US)

Correspondence Address: Keohane & D'Alessandro, 1881 Western Avenue Suite 180, Albany, NY, 12203, US

(21) Appl. No.: 12/182,229

(22) Filed: Jul. 30, 2008

(51) Int. Cl. G06Q 40/00

(52) U.S. Cl. 705/39

(57) ABSTRACT

Under the present invention a transaction is processed and analyzed for potential fraud or error. Specifically, a description of a (proposed) transaction is accessed. Among other things, the description contains an expected set of events (e.g., derived from historical data). As the transaction is being performed a set of multimedia devices will record the same. The multimedia signal(s) from the set of devices will be analyzed to determine what event(s) actually took place. The actual event(s) will be compared to the expected event(s) to determine if any deviation/difference exists. If there is a difference, and it is beyond a predetermined tolerance, a notification can be generated. Regardless, a log of the activities will be kept.

### CROSS-REFERENCE TO RELATED APPLICATIONS

This application is related in some aspects to the commonly owned and co-pending application entitled “Secure Self-Checkout,” filed Feb. 26, 2008, and which is assigned attorney docket number END920070216US1 and U.S. patent application Ser. No. 12/037,266, the entire contents of which are herein incorporated by reference. This application is related in some aspects to the commonly owned and co-pending application entitled “Smart Scanning System,” filed May 31, 2007, and which is assigned attorney docket number END920070210US1 and U.S. patent application Ser. No. 11/756,391, the entire contents of which are herein incorporated by reference. This application is related in some aspects to the commonly owned and co-pending application entitled “Portable Device-Based Shopping Checkout,” filed May 31, 2008, and which is assigned attorney docket number END920070211US1 and U.S. patent application Ser. No. 11/756,382, the entire contents of which are herein incorporated by reference. This application is related in some aspects to the commonly owned and co-pending application entitled “Item Scanning System,” filed Jul. 24, 2007, and which is assigned attorney docket number END920070222US1 and U.S. patent application Ser. No. 11/782/173, the entire contents of which are herein incorporated by reference.

### FIELD OF THE INVENTION

The present invention generally relates to self-checkout (e.g., retail). Specifically, the present invention provides a way to improve the security of self-checkout for increased loss prevention.

### BACKGROUND OF THE INVENTION

Shopping checkout (e.g., retail supermarket, etc.) is a process by which most everyone is familiar. Typical checkout involves a shopper navigating about a store collecting items(s) for purchase. Often the shopper will utilize a shopping receptacle such as a shopping cart and/or shopping basket. Upon completion of gathering the desired items, the shopper will proceed to a checkout station for checkout (e.g., bagging and payment). In recent years, many stores have become equipped with self-checkout stations whereby a shopper will scan and bag the items his/herself, and then make payment via the self-checkout station.

When shoppers in supermarkets and other stores utilize self check-out stations, it is highly desirable that the process be both rapid and secure. The more this process can be both instantaneous and 100% secure, the better. No existing process achieves these desired goals simultaneously. Self-checkout typically includes three separate functions that today are mostly lumped together at a single point of sale (POS) station: (1) enumerating each item to be purchased, and determining its price (typically, by presenting it to a bar code scanner), (2) verifying that each item is what it was claimed to be, and (3) paying for all the items. Unfortunately, with increased volumes of shoppers and instances of employee collusion, theft is growing at an alarming rate. Theft is made easier as stores implement shopper friendly conveniences such as self checkout as described above. As such there is currently no way to determine whether a shopper has switched price tags, scanned less all of the items in their cart/basket, added items to the cart/basket after checkout, etc. In view of the foregoing, there exists a need for a system that solves at least one of the above-referenced deficiencies in the related art.

### SUMMARY OF THE INVENTION

Under the present invention a transaction is processed and analyzed for potential fraud or error. Specifically, a description of a (proposed) transaction is accessed. Among other things, the description contains an expected set of events (e.g., derived from historical data). As the transaction is being performed a set of multimedia devices will record the same. The multimedia signal(s) from the set of devices will be analyzed to determine what event(s) actually took place. The actual event(s) will be compared to the expected event(s) to determine if any deviation/difference exists. If there is a difference, and it is beyond a predetermined tolerance, a notification can be generated. Regardless, a log of the activities will be kept.

A first aspect of the present invention provides a method for analyzing transactions, comprising: accessing a description of a transaction, the description comprising an expected set of events for completing the transaction; recording details of the transaction using a set of multimedia devices; and comparing the details to the description to determine if a deviation from the expected set of events occurred.

A second aspect of the present invention provides a system for analyzing transactions, comprising: a module for accessing a description of a transaction, the description comprising an expected set of events for completing the transaction; a module for recording details of the transaction using a set of multimedia devices; and a module comparing the details to the description to determine if a deviation from the expected set of events occurred.

A third aspect of the present invention provides a computer readable medium containing a program product for analyzing transactions, the computer readable medium comprising program code for causing a computer system to: access a description of a transaction, the description comprising an expected set of events for completing the transaction; record details of the transaction using a set of multimedia devices; and compare the details to the description to determine if a deviation from the expected set of events occurred.

A fourth aspect of the present invention provides a method for deploying a system for analyzing transactions, comprising; deploying a computer infrastructure operable to: access a description of a transaction, the description comprising an expected set of events for completing the transaction; record details of the transaction using a set of multimedia devices; and compare the details to the description to determine if a deviation from the expected set of events occurred.

A fifth aspect of the present invention provides a computer-implemented method for analyzing transactions, comprising: accessing a description of a transaction, the description comprising an expected set of events for completing the transaction; recording details of the transaction using a set of multimedia devices; and comparing the details to the description to determine if a deviation from the expected set of events occurred.

A sixth aspect of the present invention provides a data processing system for analyzing transactions, comprising: a memory medium comprising instructions; a bus coupled to the memory medium; and a processor coupled to the bus that when executing the instructions causes the data processing system to access a description of a transaction, the description comprising an expected set of events for completing the transaction; record details of the transaction using a set of multimedia devices; and compare the details to the description to determine if a deviation from the expected set of events occurred.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a checkout station with various shopping receptacles according to an embodiment of the present invention.

FIG. 2 shows various process flows according to the present invention according to the present invention.

FIG. 3 shows a method flow diagram according to the present invention.

FIG. 4 shows a more specific computerized implementation according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

As used herein, the following terms have the associated meanings:

“Set”—a quantity of at least one,

“Shopping Receptacle”—any container capable of holding items such as a shopping cart, a shopping basket, a shopping bag, etc.

“Multimedia Device”—means any type of camera or the like such as a still image camera, a video camera, etc.

Under the present invention a transaction is processed and analyzed for potential fraud or error. Specifically, a description of a (proposed) transaction is accessed. Among other things, the description contains an expected set of events (e.g., derived from historical data). As the transaction is being performed a set of multimedia devices will record the same. The multimedia signal(s) from the set of devices will be analyzed to determine what event(s) actually took place. The actual event(s) will be compared to the expected event(s) to determine if any deviation/difference exists. If there is a difference, and it is beyond a predetermined tolerance, a notification can be generated. Regardless, a log of the activities will be kept.

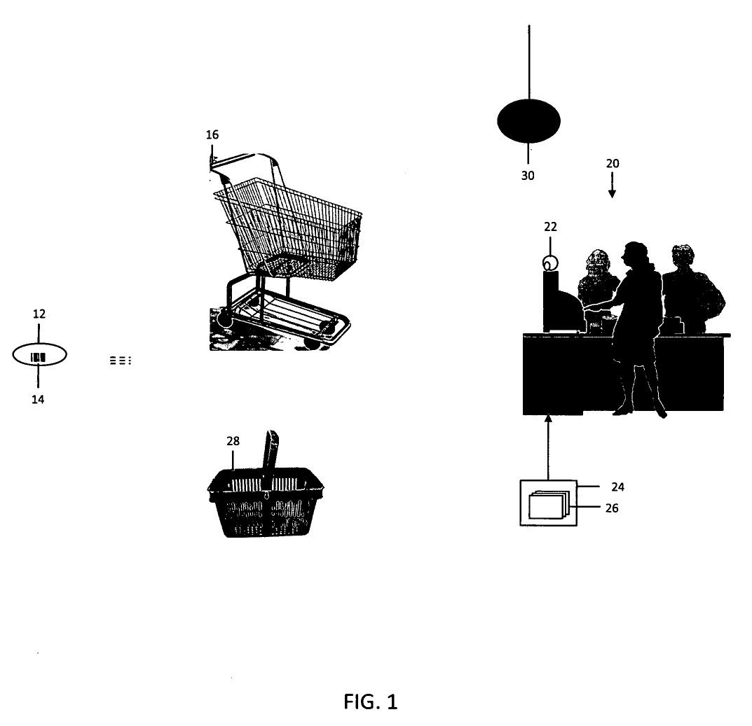

These concepts will now be explained in greater detail with respect to a retail transaction using FIG. 1. Specifically, FIG. 1 shows various shopping receptacles 16 and 28. FIG. 1 is intended to demonstrate a checkout transaction whereby items are scanned, and payment is made. As known, a scan of a barcode 14 of an item 12 (e.g., a consumer product) will be received using a scanner. Based on the barcode 14, modules 26 of transaction system/program 24 will determine an identity of item 12. When all items have been scanned, payment will be made.

During this transaction a set of multimedia devices 22 and 30 will record the transaction and generate a set of multimedia signals, which will be fed to transaction program 24 (as well as a log). Transaction program 24 will access a description for the transaction, which will include among other things an expected set of events for completing the transaction. The description can include expected prices, payment arrangements, a product to scan ratio, etc., and is typically derived from historical data. Such historical data can even be user-based. For example, if a particular customer is recognized (e.g., via a customer loyalty card, historical data for that customer could be accessed by transaction program 24. Regardless, the signal(s) from multimedia devices 22 and 30 will be will be stored in a log, and analyzed by transaction program 24 to determine the set of events that actually took place. Specifically, the details (containing the actual set of events) will be compared to the expected set of events (derived from the description of the transaction) to determine if a deviation from the expected set of events has occurred. If a deviation beyond a predetermined tolerance has occurred, a notification will be generated (e.g., alarm sounded, etc.). Regardless, the analysis/comparison, outcome, and notification (if any) will be stored in the log. The contents of the log can be used for employee training, prosecution support, etc.

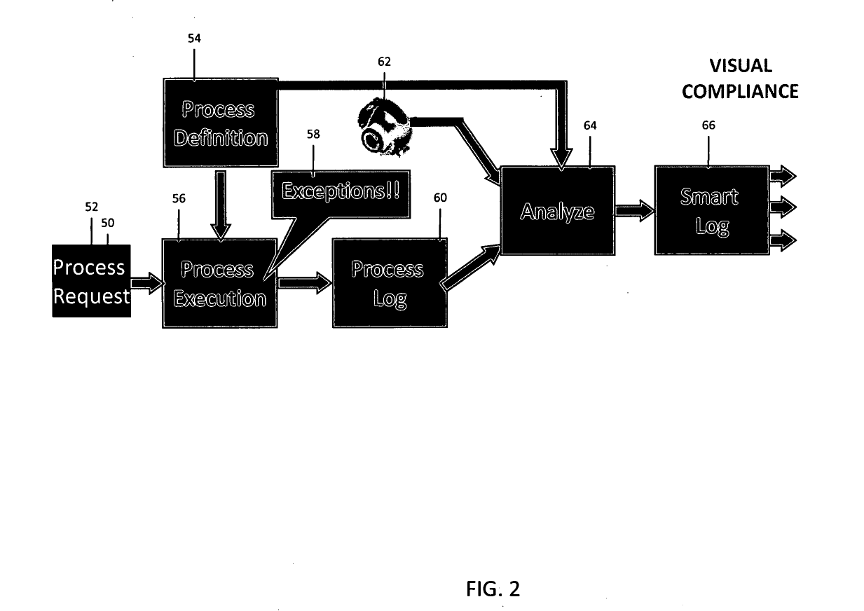

Referring now to FIG. 2, a generic process diagram 50 according to the present invention is shown. Initially, process 52 (e.g., a transaction) is initially requested. A definition/description 54 for the process is accessed as the process is executed in step 56. Various exceptions 58 could be indicated (e.g., a faulty scanning) and handled as needed. Regardless, a process log 60 is kept of the transaction events. As indicated above, a set of multimedia devices 62 will record the set of events that took place in performing the transaction. Such events will be analyzed 64 and compared to the description (that contains expected events) to determine if a deviation existed. Regardless of the outcome, the results of the analysis can be stored in a smart log 66.

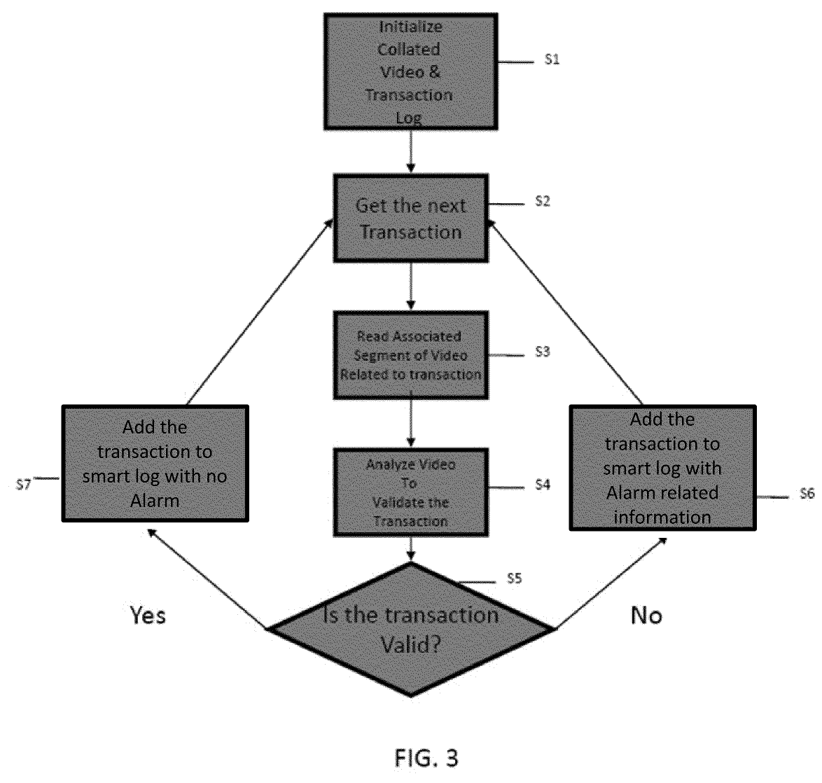

These concepts are further explained via the method flow diagram of FIG. 3. In step S1, a video (e.g., multimedia device) and transaction log is initialized and collated. In step S2, a next transaction is obtained. In step S3, an associated video segment (e.g., multimedia signal) related to the transaction is read. In step S4, the video (e.g., multimedia signal) is analyzed. In step S5, it is determined whether the transaction is valid. This is typically done by comparing the actual events as determined from the video segment to expected events as derived from the event description. If the comparison yields a deviation beyond a predetermined threshold, the transaction is not valid, the transaction is added to a smart log and a corresponding alarm/notification is generated in step S6. If the comparison yields a deviation within a predetermined threshold (or no deviation at all), the transaction is valid and will be added to the smart log in step S7.

### II. Computerized Implementation

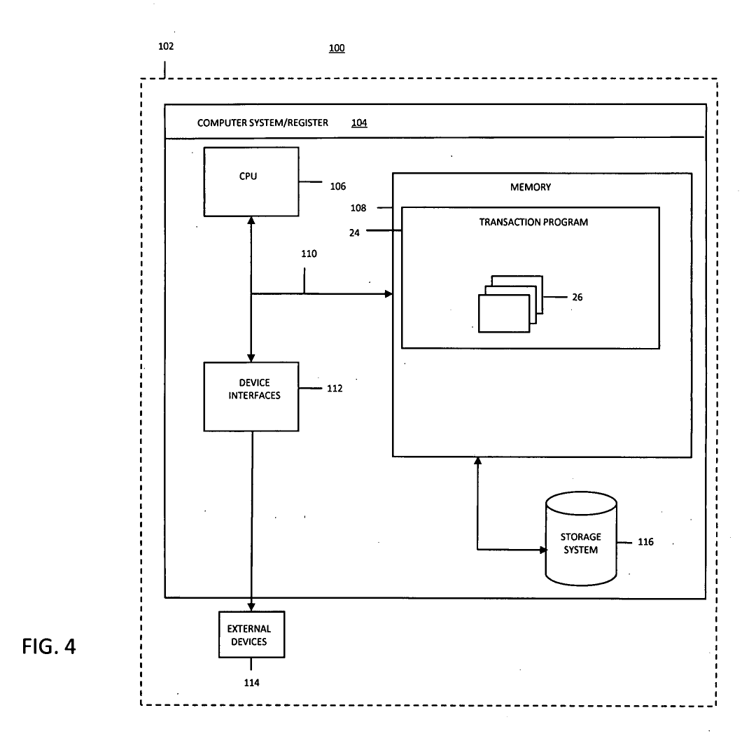

Referring now to FIG. 4, a computerized implementation 100 of the present invention is shown. As depicted, implementation 100 includes computer system/register 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

As shown, computer system/register 104 includes a processing unit 106, a memory 108, a bus 110, and device interfaces 112. Further, computer system/register 104 is shown communicating with one or more external devices 114 such as multimedia devices 22 and or 30 that communicate with bus via device interfaces. In general, processing unit 106 executes computer program code, such as transaction software/program 24, which is stored in memory 108 and/or storage system 116. While executing computer program code, processing unit 106 can read and/or write data to/from memory 108, storage system 116, and/or device interfaces 112. Bus 110 provides a communication link between each of the components in computer system/register 104. Although not shown, computer system/register 104 could also include I/O interfaces that communicate with: one or more external devices such as a kiosk, a checkout station, a keyboard, a pointing device, a display, etc.); one or more devices that enable a user to interact with computer system/register 104; and/or any devices (e.g., network card, modem, etc.) that enable computer system/register 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process of the invention. Moreover, computer system/register 104 is only representative of various possible computer systems that can include numerous combinations of hardware. To this extent, in other embodiments, computer system/register 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, device interfaces 112 can comprise any module for exchanging information with one or more external devices. Still further, it is understood that one or more additional components (e.g., system software, math co-processing unit, etc.) not shown in FIG. 4 can be included in computer system/register 104.

Storage system/log 116 can be any type of system capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system/register 104.

Shown in memory 108 of computer system/register 104 is transaction program 24, which includes a set of modules 26. The modules generally provide the functions of the present invention as described herein. Specifically (among other things), set of modules 26 is configured for: accessing a description of a transaction, the description comprising an expected set of events for completing the transaction; recording details of the transaction using a set of multimedia devices; comparing the details to the description to determine if a deviation from the expected set of events occurred; storing results of the comparing in a log; generating a notification if the deviation is beyond a predetermined tolerance; determining a score based on the deviation; performing an assessment of the comparing and the deviation; using results of the comparing in training; receiving a set of multimedia signals from the set of multimedia devices comprising the details, the multimedia signal being used for the comparing.

While shown and described herein as a transaction analysis solution, it is understood that the invention further provides various alternative embodiments. For example, in one embodiment, the invention provides a computer-readable/useable medium that includes computer program code to enable a computer infrastructure to provide analyze transactions. To this extent, the computer-readable/useable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 4) and/or storage system 116 (FIG. 4) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to provide analyze transactions. In this case, the service provider can create, maintain, support, etc., a computer infrastructure, such as computer infrastructure 102 (FIG. 4) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for analyzing transactions. In this case, a computer infrastructure, such as computer infrastructure 102 (FIG. 4), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system/register 104 (FIG. 4), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of interning private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method for analyzing transactions, comprising:
accessing a description of a point of sale transaction from historical data, the description comprising an expected set of user events for completing the transaction;
recording details of actual user events performed during an actual point of sale transaction using a set of multimedia devices;
analyzing the details of the actual user events; and
comparing the details of the actual user events to the description to determine if a deviation from the expected set of user events occurred.

2. The method of claim 1, further comprising storing results of the comparing in an outcome smart log.

3. The method of claim 1, further comprising generating a notification if the deviation is beyond a predetermined tolerance.

4. The method of claim 1, further comprising determining a score based on the deviation.

5. The method of claim 4, further comprising performing an assessment of the comparing.

6. The method of claim 1, further comprising using results of the comparing in training.

7. The method of claim 1, further comprising receiving a set of multimedia signals from the set of multimedia devices comprising the details, the multimedia signal being used for the comparing.

8. A system for analyzing transactions, comprising:
a module for accessing a description of a point of sale transaction from historical data, the description comprising an expected set of user events for completing the transaction;
a module for recording details of actual user events performed during an actual point of sale transaction using a set of multimedia devices;
a module for analyzing the details of the actual user events; and
a module for comparing the details of the actual user events to the description to determine if a deviation from the expected set of user events occurred.

9. The system of claim 8, further comprising a module for storing results of the comparing in an outcome smart log.

10. The system of claim 8, further comprising a module for generating a notification if the deviation is beyond a predetermined tolerance.

11. The system of claim 8, further comprising a module for determining a score based on the deviation.

12. The system of claim 11, further comprising a module for performing an assessment of the comparing and the deviation.

13. The system of claim 8, further comprising a module for using results of the comparing in training.

14. The system of claim 8, further comprising a module for receiving a set of multimedia signals from the set of multimedia devices comprising the details, the multimedia signal being used for the comparing.

15. A computer readable medium containing a program product for analyzing transactions, the computer readable medium comprising program code for causing a computer system to:
access a description of a point of sale transaction from historical data, the description comprising an expected set of user events for completing the transaction;
record details of actual user events performed during an actual point of sale transaction using a set of multimedia devices;
analyze the details of the actual user events; and
compare the details of the actual user events to the description to determine if a deviation from the expected set of user events occurred.

16. The computer readable medium containing the program product of claim 15, the computer readable medium further comprising program code for causing the computer system to store results of the comparing in an outcome smart log.

17. The computer readable medium containing the program product of claim 15, the computer readable medium further comprising program code for causing the computer system to generate a notification if the deviation is beyond a predetermined tolerance.

18. The computer readable medium containing the program product of claim 15, the computer readable medium further comprising program code for causing the computer system to determine a score based on the deviation.

19. The computer readable medium containing the program product of claim 18, the computer readable medium further comprising program code for causing the computer system to perform an assessment of the comparing and the deviation.

20. The computer readable medium containing the program product of claim 15, the computer readable medium further comprising program code for causing the computer system to use the results of the comparing in training.

21. The computer readable medium containing the program product of claim 15, the computer readable medium further comprising program code for causing the computer system to receive a set of multimedia signals from the set of multimedia devices comprising the details, the multimedia signal being used for the comparing.

22. A method for deploying a system for analyzing transactions, comprising:
deploying a computer infrastructure being operable to:
access a description of a point of sale transaction from historical data, the description comprising an expected set of user events for completing the transaction;
record details of actual user events performed during an actual point of sale transaction using a set of multimedia devices;
analyze the details of the actual user events; and
compare the details of the actual user events to the description to determine if a deviation from the expected set of user events occurred.
